(19) United States
(12) Patent Application Publication
(10) Pub. No.: US 2026/0216924 A1
(43) Pub. Date: Jul. 30, 2026

(54) CLASSIFICATION OF MONOLAYER AND MULTILAYER PLASTICS INCLUDING RELATED METHODS, APPARATUSES, AND SYSTEMS

(71) Applicant: BATTELLE ENERGY ALLIANCE, LLC, Idaho Falls, ID (US)

(72) Inventors: Jeffrey A. Lacey, Idaho Falls, ID (US); Lorenzo Vega Montoto, Idaho Falls, ID (US); Blesson Isaac, Idaho Falls, ID (US); Miranda Wachs Kuns, Idaho Falls, ID (US); Yuzhou Wang, Idaho Falls, ID (US)

(21) Appl. No.: 19/147,669

(22) PCT Filed: Jan. 12, 2024
(86) PCT No.: PCT/US2024/011505

§ 371 Date: Jul. 11, 2025

Related U.S. Application Data
(60) Provisional application No. 63/480,210, filed on Jan. 17, 2023.

(51) Int. Cl. B29B 17/02; B29L 9/00; G06N 20/00

(52) U.S. Cl. CPC B29B 17/02; G06N 20/00; B29B 2017/0203; B29B 2017/0279; B29L 2009/00

(57) ABSTRACT

A method includes obtaining near-infrared (NIR) spectroscopic data associated with a solid waste sample; inputting the NIR spectroscopic data into a classification model, the classification model being trained with NIR spectroscopic training data of multiple monolayer plastic samples of different monolayer plastics and multiple multilayer plastic samples of different multilayer plastics; and classifying the solid waste sample into one of multiple classes based on an output result of the classification model on the NIR spectroscopic data, the multiple classes including different monolayer plastic classes associated with respective different monolayer plastics and a multilayer plastic class associated with the different multilayer plastics. The method may further comprise obtaining Raman spectroscopic data associated with a classified multilayer plastic sample; and determining, based on the Raman spectroscopic data, one or more compositions of one or more layers of the classified multilayer plastic sample.

### CROSS-REFERENCE TO RELATED APPLICATIONS

This application is a national phase entry under 35 U.S.C. § 371 of International Patent Application PCT/US2024/011505, filed Jan. 12, 2024, designating the United States of America and published as International Patent Publication WO 2024/155541 A1 on Jul. 25, 2024, which claims the benefit under Article 8 of the Patent Cooperation Treaty of the filing date of U.S. Provisional Patent Application Ser. No. 63/480,210, filed Jan. 17, 2023, for “NON-DESTRUCTIVE CLASSIFICATION AND CHARACTERIZATION OF MULTILAYERED PLASTICS AND RELATED SYSTEMS AND METHODS,” the disclosure of each of which is hereby incorporated herein in its entirety by this reference.

### STATEMENT REGARDING FEDERALLY SPONSORED RESEARCH OR DEVELOPMENT

This disclosure was made with government support under contract No. DE-AC07-05-ID14517 awarded by the United States Department of Energy. The government has certain rights in the disclosure.

### TECHNICAL FIELD

This disclosure relates generally to classification of monolayer and multilayer plastics, and more specifically, to methods of classifying, sorting, and/or recycling plastic solid waste including monolayer and multilayer plastic solid waste using near-infrared (NIR) spectrography and machine learning (ML) models, as well as to related apparatuses and systems.

### BACKGROUND

Plastic waste has diverse chemical compositions, structures (e.g., monolayer or multilayer), and formulations that should be accurately sorted before recycling and/or upcycling processes. Recyclers use various processes for sorting and identifying types of monolayer structures of plastic waste including spectroscopy to determine a chemical composition of a particular plastic sample but have not had reliable methods of identifying multilayer plastics and its multilayer structures.

### BRIEF DESCRIPTION OF THE DRAWINGS

FIGS. 1(a)-1(h) is a group of subplots graphically depicting representative near-infrared (NIR) spectra obtained for each respective class of collected solid waste samples.

FIGS. 2(a)-2(f) is a group of subplots illustrating the positions of NIR spectra data points of all of the solid waste samples, projected onto a transformed space defined by three principal components with the largest amount of variance according to different preprocessing methods.

FIGS. 3(a)-3(d) are subplots indicating the impact of preprocessing on a selected (e.g., optimal) number of principal components.

FIG. 4 is a graph showing performance metrics of the four machine learning (ML) models under different preprocessing methods on a test dataset.

FIGS. 5(a)-5(e) are various figures associated with results and other analysis according to one or more examples of the disclosure.

FIG. 6 is a flowchart of a method for classification of plastic solid waste based on NIR spectroscopy according to one or more examples of the disclosure.

FIG. 7(a) is a system for sorting and/or recycling plastic solid waste according to one or more examples of the disclosure.

FIG. 7(b) is another system for sorting and/or recycling plastic solid waste according to one or more examples of the disclosure.

FIG. 8 is a flowchart of a method of efficiently sorting and/or recycling plastic solid waste based on NIR and Raman spectroscopy according to one or more examples of the disclosure.

FIG. 9 is a block diagram of an example device that, in various examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the disclosure but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

A large quantity of municipal solid waste (MSW) is produced around the world and its generation across major metropolitan cities worldwide is expected to rise. While accounting for a large fraction of the MSW, around half of the plastics produced each year are thrown away, posing significant challenges to the environment. To reduce plastic pollution and save natural resources through utilization of recovered plastics, many countries have passed legislation to phase out non-recyclable plastic products. Furthermore, for some special cases where access to resources is limited (e.g., combat environment, disaster relief), the utilization and conversion of plastic waste into functional materials would ease logistic burdens and improve a capability to handle complex situations.

To support the recycling of plastic wastes, efficient sorting strategies are desirable due to the incompatibility of certain types of plastic wastes in downstream processing, recycling, and conversion technologies. Certain online sensing techniques have been proposed as options for dealing with waste material identification and sorting. These techniques include Raman spectroscopy, X-ray diffraction (XRD), X-ray fluorescence (XRF), laser-induced breakdown spectroscopy (LIBS), and near-infrared (NIR) spectroscopy. In addition, ultraviolet (UV), visible (VIS), and mid-infrared (MIR) spectroscopies have been utilized to characterize paper and plastics. A summary of characteristics of conventional sensing techniques, such as reliability and accuracy, is presented in Table 1.

TABLE 1
Performance of several sensing technologies.

| | Material | | | | |
|---|---|---|---|---|---|
| Technologies | Diversity | Accuracy | Cost | Reliability | Hazard |
| LIBS | L | M | H | L | laser |
| | | | | | exposure |
| Raman | H | H | M | M | laser |
| | | | | | exposure |
| NIR | H | H | L | H | none |
| XRF | M | M | H | H | X-ray |
| | | | | | exposure |

(L = Low, M = Medium, and H = High)

In general, molecular spectroscopies provide information on the molecular structure of materials that could be used as fingerprints for classification purposes. NIR spectroscopy has been utilized for sorting certain types of waste plastics in advanced material recovery and recycling facilities. NIR may, in some instances, involve scanning in the wavelength range from 800 nm to 2500 nm to provide information on the vibrations of molecular bonds including O—H, C—H, and N—H. In at least some cases, NIR may not work as well on dark plastics as on light-colored plastics since the dyes contained in dark plastics may absorb waves strongly at the wavelengths used in NIR spectroscopy.

MIR spectroscopy has been used to characterize polyolefins with longer wavelengths ranging from 2.5 μm to 25 μm. The absorption peaks in these wavelengths provide information on C—Cl stretching, CH₂ and CH₃ bending, and C—O stretching. Unlike NIR, MIR is not as hampered by the presence of dark dyes and may be used to identify black and other dark plastics.

Raman spectroscopy has been used successfully to identify environmental microplastics. Raman spectroscopy is complementary to NIR and utilizes a visible laser light source to excite Raman scattering on samples. Scattered photons carry a slightly different energy and contain information on the microstructure and chemical bonds of materials of interest. However, more stringent application conditions are used to acquire a good quality signal, as Raman spectroscopy relies on inelastic photon scattering, which may happen only for one in around ten million photons. While specific examples herein describe using Raman spectroscopy in combination with NIR, other sensing techniques may be used in combination with NIR.

Atomic spectroscopies, which provide information on the elemental composition, may also be leveraged for waste classification. However, these techniques have limited performance when distinguishing between plastics with different structures and similar elemental compositions, such as those of low-density polyethylene (LDPE) and high-density polyethylene (HDPE).

XRF detects a variety of elements (e.g., zinc, copper, nickel, iron, manganese, chromium, and titanium) that may be present in materials by analyzing fluorescence light after an incident X-ray reacts with the materials. XRF has been used to study biochars and may be able to identify the presence of plastic contaminants with substantially 91% confidence.

LIBS creates plasma plumes by shooting strong laser pulses at a material surface and analyzes a light emission out of the plasma. The obtained optical spectrum from the plasma includes peaks corresponding to specific elements, indicating the presence and abundance of the chemical elements in the samples.

The spectroscopy technique selected for classification should exhibit satisfactory performance in a diverse range of applications and have minimal maintenance requirement and operational hazards. In one or more examples of the disclosure, NIR spectroscopy is selected at least in part due to its relatively low cost, ease of operation, minimum hazards, and high amount of revealed molecular information.

Accordingly, a plastic waste classification system may be based at least in part on spectrum data collected by NIR spectroscopy and ML algorithms to support the efficient sorting of solid waste, such as plastic solid waste. By way of non-limiting example, six different types of monolayer plastics (e.g., plastic code numbers 1-6), paper, and multilayer plastic packaging wastes are used for classification modeling. The different monolayer plastics (e.g., plastic code numbers 1-6) may include polyethylene terephthalate (PET), high-density polyethylene (HDPE), polyvinyl chloride (PVC), low-density polyethylene (LDPE), polypropylene (PP), and polystyrene (PS). Regarding the multilayer plastics, various combinations of two or more of the different monolayer plastics may be used for the classification modeling, and/or a representative sampling of actual (common) multilayer plastic packaging or items used in commerce and/or found in disposal.

As described herein, over 2600 NIR spectra were collected from samples of these plastics from municipal solid waste. Different data preprocessing methods were explored and multiple ML classification algorithms were evaluated based on performance metrics. Although a number of methods are demonstrated to be useful, one algorithm is shown to have 99% identification accuracy. Besides efficient and accurate sorting of major monolayer plastic wastes, it is demonstrated that methods according to one or more examples are suitable for the identification of multilayer plastic solid wastes. The model was transferred to a small-scale classification system, including a microcomputer and miniature spectrometer, for use on reclaimed solid wastes. The result has confirmed the utility of ML-based sorting techniques for waste classification and recycling in diverse circumstances, including household waste management, disaster relief, industry-scale recycling, and so on.

Spectroscopy techniques provide numerical signals representing chemical components or properties of the sample that may be used for material classification. In practice, the analytical signal is ultimately a voltage or current passing through an analytical device and is not a direct measurement of the chemical property. In addition, spectroscopic-based sensors generally exhibit several common characteristics: datasets are multivariate and highly correlated, represent convoluted main effects, and corrupted by colored noise (i.e., correlated and heteroscedastic). In consideration of the above, it may be helpful for signals to be conditioned and prepared to be employed by modeling strategies that handle the intrinsic characteristics of these datasets. The latest advances in computing power may further enable application of ML to the analysis of spectroscopy data. These techniques may recognize subtle differences between the spectra of different classes to help produce even more accurate and efficient classification models.

According to the present disclosure, a classification system may achieve automatic classification of monolayer plastic, multilayer plastic, and paper MSW. It has been discovered that combining the chemical information obtained by NIR spectroscopy with the prediction power of ML models enables an efficient automatic sorting of waste materials with high accuracy. Notably, a suitably pre-trained classification model enables the identification of characteristics of the different multilayer plastics from their monolayer counterparts, possibly owing to the large sensing depth of NIR light incorporating signals from several layers.

The over two thousand NIR spectra of real plastic and paper wastes were collected to simulate a real-world situation. In addition, several preprocessing strategies were explored to investigate the impact on prediction accuracy. Further, four (4) ML classification algorithms were evaluated based on the performance metrics. It is noted that the k-nearest neighbor (KNN) model offered good performance with the highest accuracy of over 99%. Again, the model was transferred to a small-scale classification system, for example, a microcomputer and compact spectrometer for on-field or in-line measurement. It was confirmed that spectral-based techniques and, in particular, NIR spectrography, in combination with specifically trained ML models, offer an advantageous solution for the efficient recycling of MSW.

Collection of Solid Waste Samples. A sample matrix may be composed of plastics #1-6 (i.e., PET (1), HDPE (2), PVC (3), LDPE (4), PP (5), and PS (6)), paper, and multilayer plastic packaging. Waste samples identified, procured, and catalogued were unique based on product, brand, organoleptic characteristics, or a combination of the three. Bottles, containers, packaging, piping, and packets of different shapes, sizes, colors, transparencies, and textures are examples of products collected. Samples were collected from superstores, household trash bins, and landfills. These samples were emptied and cleaned. For monolayer plastic samples to qualify as collectible, the products had to have a recycling identification label attached. All collected samples were categorized into classes based on the plastic recycling symbols on the label. In total, 335 samples of different polymeric compositions were investigated.

Table 2 below shows a breakdown of the quantity of each sample class collected. The number of PVC samples is limited due to resource constraints.

TABLE 2
Number of spectra collected on each material.

| Polymer | | | | | | | | |
|---|---|---|---|---|---|---|---|---|
| Type | | | | | | | | Multi- |
| (Class | PET | HDPE | PVC | LDPE | PP | PS | Pa- | layer |
| Code) | (1) | (2) | (3) | (4) | (5) | (6) | per | plastic |
| Number | 53 | 38 | 10 | 44 | 52 | 39 | 40 | 59 |
| of | | | | | | | | |
| samples | | | | | | | | |
| Number | 528 | 296 | 98 | 361 | 386 | 296 | 396 | 292 |
| of | | | | | | | | |
| spectra | | | | | | | | |

Acquisition of NIR Spectra. NIR spectra acquisition is accomplished using, for example, a compact Ocean Insight NIRQUEST® spectrometer with a 45° diffuse reflectance probe with an inbuilt halogen light source. In one or more examples, the spectra may be collected in reflectance mode with 500 ms integration time and averaged over four (4) scans. Each sample may be scanned in five (5) locations on the front and back of the sample (for a total of 10 spectra) using a point-and-shoot technique to assess effects driven by the non-uniformity of samples. Spectra with poor quality were removed. A total of 2361 NIR spectra were collected.

Ground truth information regarding the chemical composition of the catalogued monolayer samples is collected from manufacturer printed labels. On the other hand, the multilayer plastic packaging or samples are grouped into one category (e.g., “multilayer plastic”), given the lack of specific information on the composition of these samples. The multilayer plastic samples have different materials for the outmost layer, adhesive, and innermost layer, but generally have a thin aluminum foil as a barrier layer. The NIR reflectance spectra for these samples were collected in the range between 896 and 2123 nm with 512 pixels.

In one or more examples, the multilayer plastic waste samples comprise various combinations of two or more of the different monolayer plastics (i.e., various combinations of two or more of PET, HDPE, PVC, LDPE, PP, and PS including paper). In one or more examples, the multiple multilayer plastic samples comprise a representative sampling of actual (common) multilayer plastic packaging or items (e.g., common multilayer plastic packaging or items used in commerce and/or found in disposal).

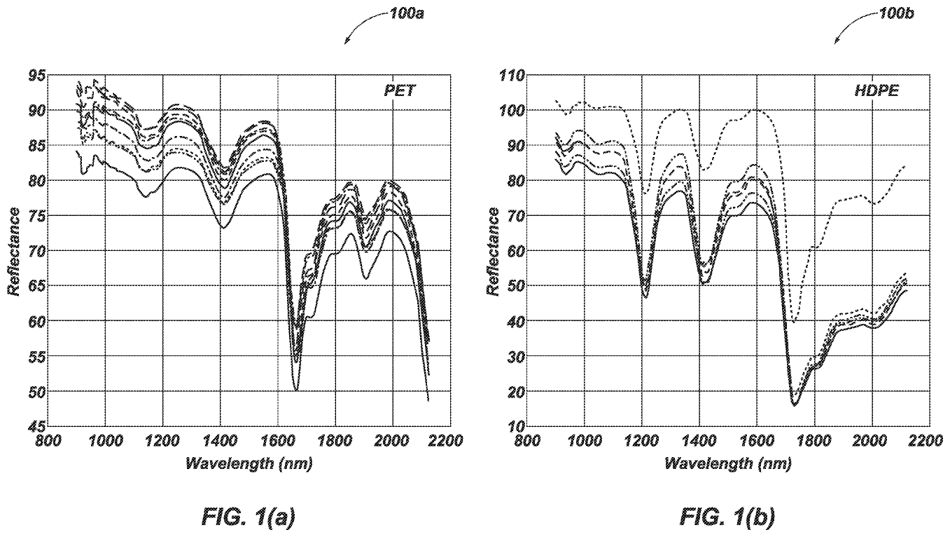

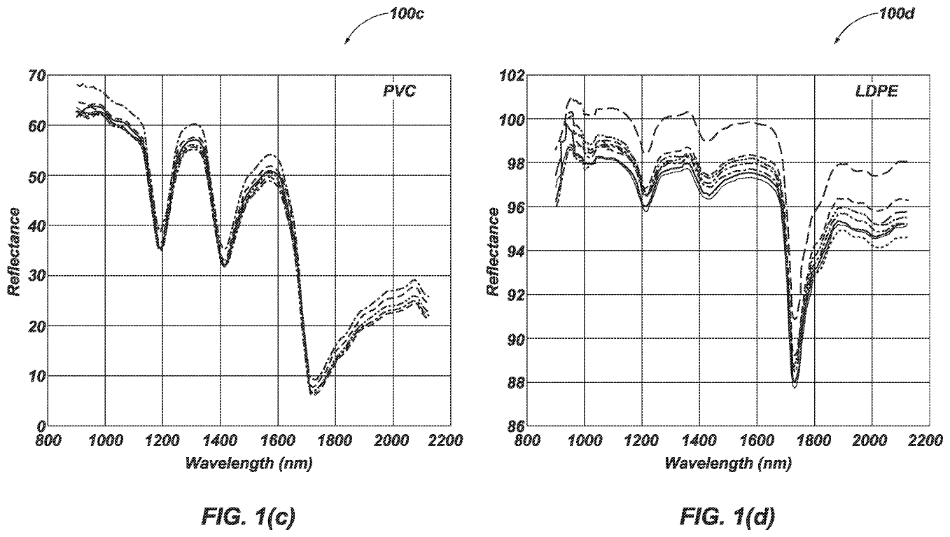

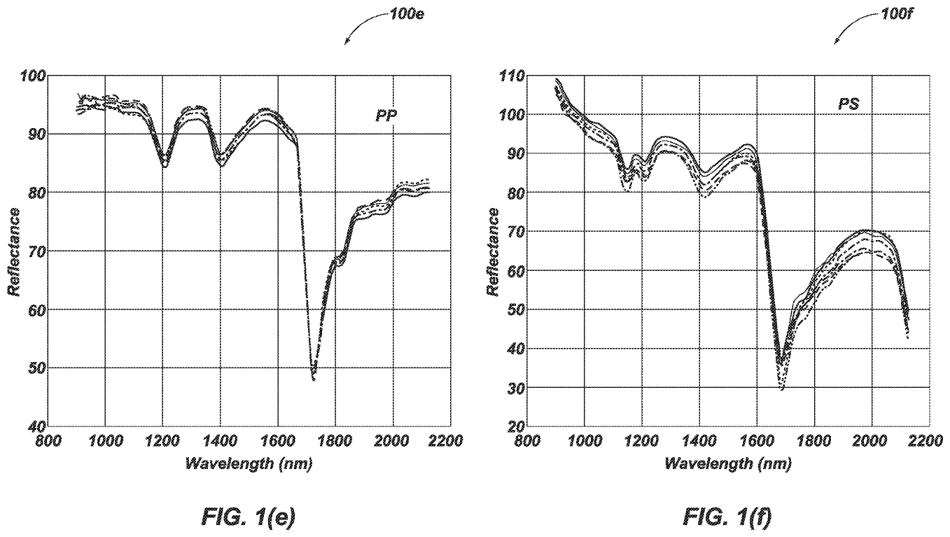

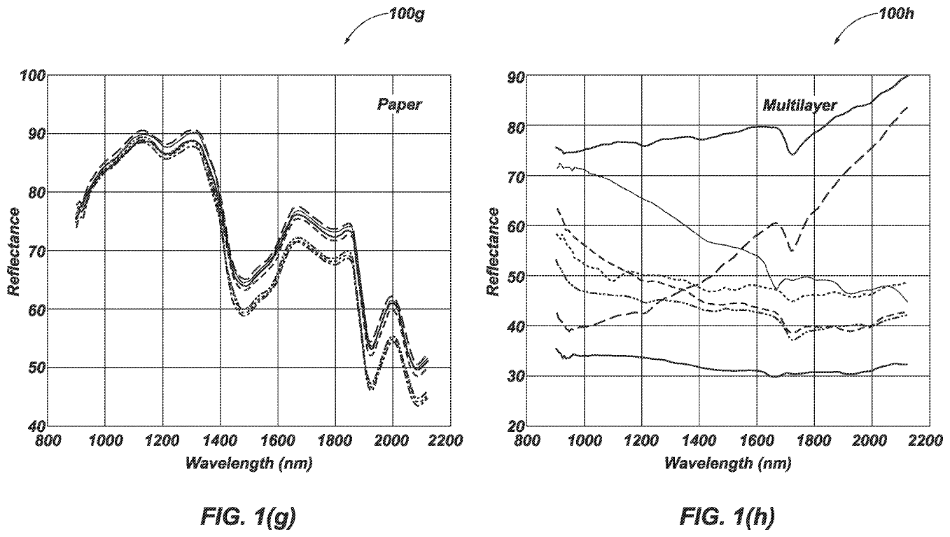

FIGS. 1(a)-1(h) is a group of subplots graphically depicting representative NIR spectra for each respective class of collected samples represented in Table 2. More particularly:

FIG. 1(a) is a subplot 100a depicting representative NIR spectra of polyethylene terephthalate (PET) (plastic #1);

FIG. 1(b) is a subplot 100b depicting representative NIR spectra of high-density polyethylene (HDPE) (plastic #2);

FIG. 1(c) is a subplot 100c depicting representative NIR spectra of polyvinyl chloride (PVC) (plastic #3);

FIG. 1(d) is a subplot 100d depicting representative NIR spectra of low-density polyethylene (LDPE) (plastic #4);

FIG. 1(e) is a subplot 100e depicting representative NIR spectra of polypropylene (PP) (plastic #5);

FIG. 1(f) is a subplot 100f depicting representative NIR spectra of polystyrene (PS) (plastic #6); and

FIG. 1(g) is a subplot 100g depicting representative NIR spectra of paper.

FIG. 1(h) is a subplot 100h depicting representative NIR spectra of the multilayer plastics.

In FIGS. 1(a)-1(h), some of the multilayer samples were sectioned by microtome (e.g., EPREDIA™ HM355S, without limitation) and examined by confocal Raman spectroscopy (e.g., Bruker SENTERRA, without limitation). The laser wavelength was 532 nm and acquisition time was two seconds (2 s). A 20× microscope objective was used to focus the laser beam. The collected spectra were analyzed by the built-in software provided with the spectroscopy.

As observed in FIGS. 1(a)-1(h) (e.g., in subplot 100d of FIG. 1(d)), NIR spectra below 1000 nm may exhibit a large variance due to the low illumination quality near this wavelength from the halogen lamp, thus introducing noise to the signal. Accordingly, the range of NIR spectrum used for ML models is selected from substantially 1000 nm to substantially 2123 nm.

Also as observed in FIGS. 1(a)-1(h), there is a noticeable amount of baseline shift and drift when the original reflectance data are employed, owing to different surface quality and slight change in the relative position between the probe head and sample surface. In addition, the reflectance amplitude may be impacted by the color that is not necessarily connected to the material molecular structure.

Data preprocessing may, in some instances, be helpful to remove baseline shift, drift, additive, and multiplicative effects on spectroscopic data. The application of mathematical methods may effectively produce data centered around zero and with a maximum standard deviation of one unit. Several feature normalization methods were applied to reduce the variance in the collected spectra to enhance model robustness, including normalization, standardization, and min-max scaling. Normalization rescales the spectrum such that the sum of the square of the elements equals one. Standardization scales the data by removing the mean and dividing them by the variance. Min-max scaling rescales the magnitude of the spectrum to the range between 0 and 1.

A Savitzky-Golay smoothing and differentiation filtering may be used to reduce high frequency noise in the signal due to its smoothing properties as well as removing low frequency signal (e.g., due to offsets and slopes, without limitation) using differentiation. In this disclosure, the impact of smoothing, first derivative, and second derivative on the performance of ML models are explored.

Principal Component Analysis (PCA) is an unsupervised data analysis tool to explore intrinsic structure and reduce dimensionality of data. PCA is a method to perform a projection of the data onto a lower dimensional estimate of itself while preserving as much variance as possible, thereby reducing the high dimension of the original space to a relatively simple low dimensional subspace. PCA may produce a new rotated space described by a smaller set of new orthogonal variables, called principal components (PCs). Latent variable methods such as Principal Component Regression (PCR) and Partial Least Squares (PLS) are both connected to PCA and are also methods to analyze spectroscopy data.

Four (4) different machine learning algorithms are compared: K-nearest Neighbors (KNN), Support Vector Machine (SVM), Decision Tree (DT), and Partial Least Square Discriminant Analysis (PLS-DA). KNN works on a simple principle by calculating a data point's distance to its neighbors. It is classified as a specific class if most of its neighboring elements belong to the same class. The only hyperparameter is the number of neighbors in the distance calculation. In one or more examples, the number of neighbors is set to one (1) to provide the lowest error rate. SVM works in hyperspace where it intends to find a boundary between classes that maximizes the margins, or distances, between the boundary and its nearest data points. A data point is classified based on its position relative to the boundaries. The method may be efficient in high-dimensional space, but the training may be time consuming. SVM has several kernel options; in one or more examples, a Radial Basis Function kernel was selected due to its high performance. DT is a classification algorithm with a flowchart structure. Each node may partition the dataset into subsets based on the features. The partition is complete when all the data at a node belong to the same class. The structure of DT may be complicated with too many branches that may lead to overfitting. DT also tends to have problems with imbalanced data. PLS methodology based on PCA has been modified to be used as a discriminant and classification method referred to as PLS-DA. This is a method that may be employed in various scientific areas: genomics, proteomics, metabolomics, as well as in food and pharmaceutical sciences.

Many figures of merit exist to assess the quality of multi-class classification. These characteristics are calculated for samples using class membership ground truth that is known a priori. Three (3) important figures of merit are “recall” (also known as “sensitivity”), “precision,” and “F1 score.” Recall represents the probability of a model to properly identify a sample. The closer the recall is to one (1), the less likely is the model to produce false negative results. A test with high recall tends to capture most, if not all possible positive conditions without missing anything. Thus, a model with high recall is often desired. Precision represents the probability of a model to produce identification without giving false positive results. This factor may be used when evaluating waste classification models as wrongly identified materials may compromise the recycling processes, such as catalyst poisoning. Both factors of recall and precision are useful, and a useful model may have both high recall and precision. To directly compare the performance of different models, it is also convenient to compare the F1 score (which is the harmonic mean of recall and precision). Accuracy is a composite measurement that may be determined from sensitivity and specificity when prevalence (e.g., a proportion of a population with a specific characteristic) is known. The numerical value of accuracy represents the proportion of correct results (both true positive and true negative) in the selected population. However, accuracy should be interpreted cautiously since it is impacted by the prevalence. It is possible to have high sensitivity and specificity, while having poor accuracy.

The dataset shown in Table 2 was divided randomly into a training set (80%) and a test set (20%). Stratified splitting was used to divide the dataset to ensure that sample types of high and low prevalence were included in both datasets. To avoid overfitting, a ten-fold cross-validation was used to further divide the training set into training and validation sets. The tuning of model hyperparameters was conducted on the validation set and the macro-averaged performance metrics were used to select the best performing models.

Representative unprocessed NIR spectra on six types of monolayer plastic, paper, and multilayer plastic waste are represented in FIGS. 1(a)-1(h). The reflectance spectra on the plastics show major absorption bands near 1200 nm, 1400 nm, and 1700 nm, which coincide with the vibrational energy or the second overtone of C—H, O—H, and N—H bonds in polymer materials. The NIR spectra of paper are different, showing an absorption peak near 1470 nm. Apart from the evident absorption peaks, there are small differences in the spectra that may facilitate the classification. For example, the shapes of the reflectance curve at the long wavelength end are different between HDPE and LDPE. The light absorption near 1900 nm is stronger on HDPE compared to LDPE whose reflectance is rather constant between 1900 nm and 2100 nm. For PET, strong absorption near 2100 nm could become useful when trying to differentiate it from other wastes. On the other hand, the NIR spectra of multilayer packaging exhibit a larger variability in shape and amplitude compared to monolayer plastics. These samples are usually made to preserve food quality and thus have a larger range of variability in color, composition, and structure depending on the shelf life and the content inside.

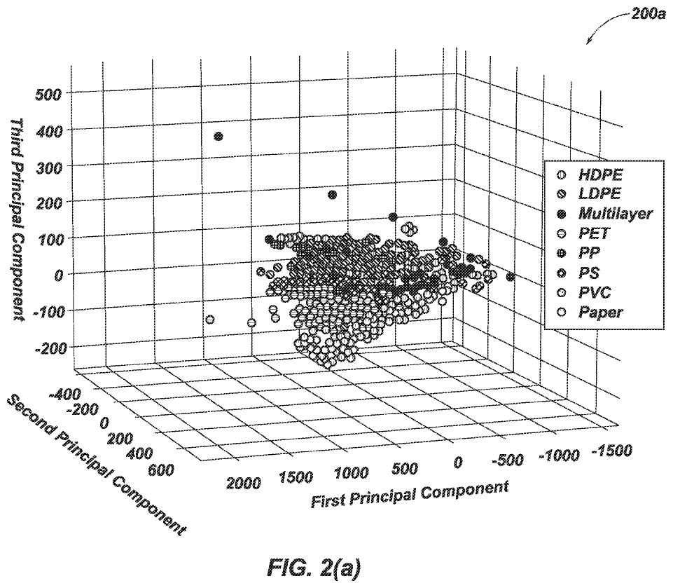

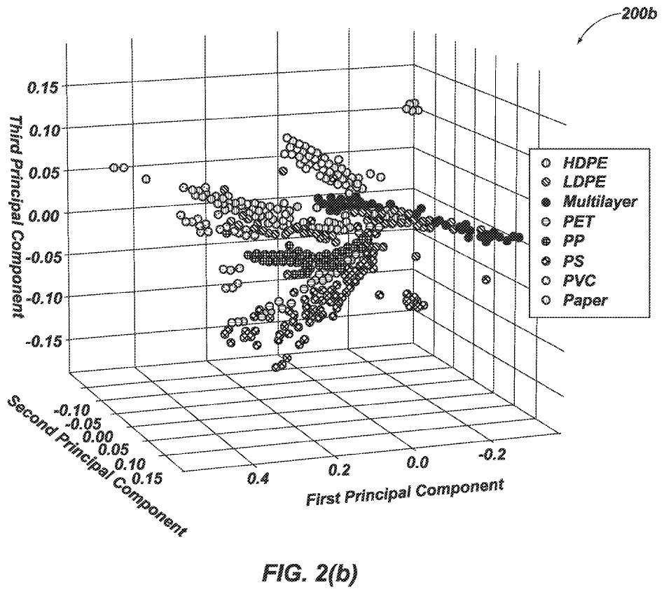

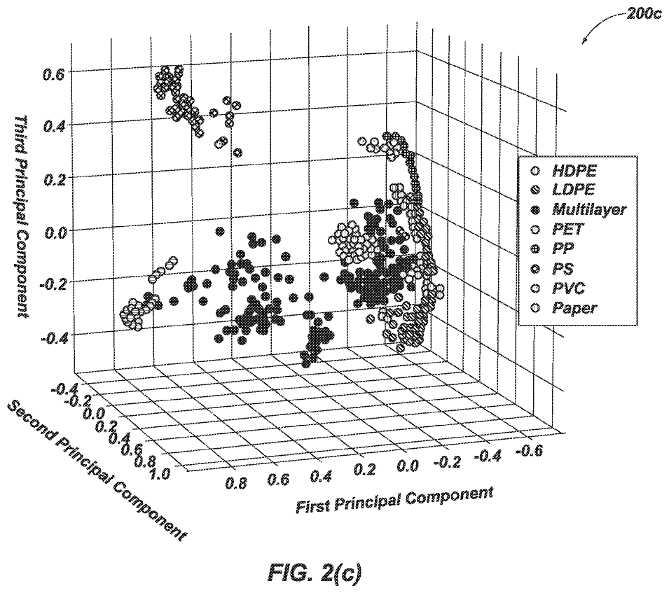

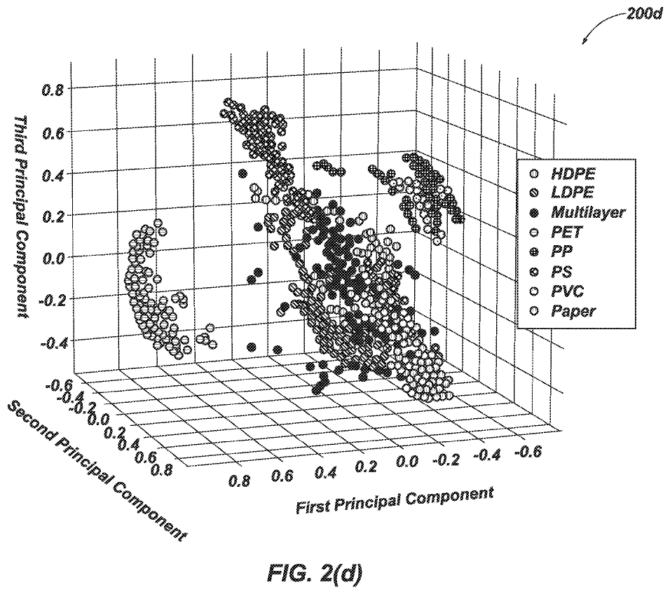

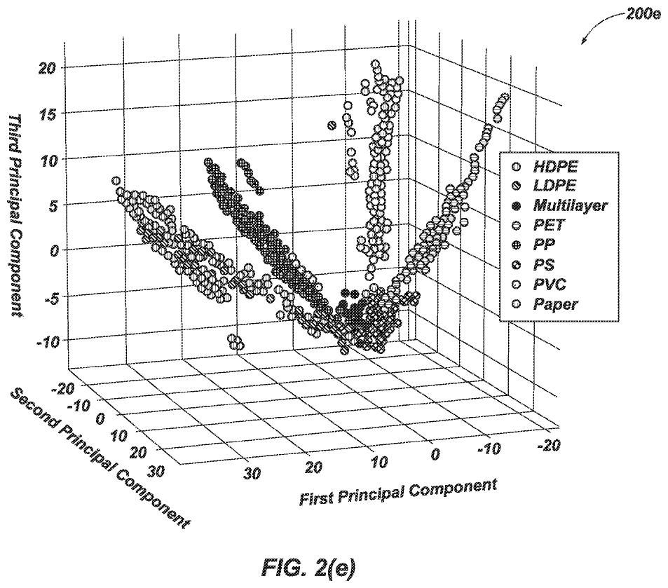

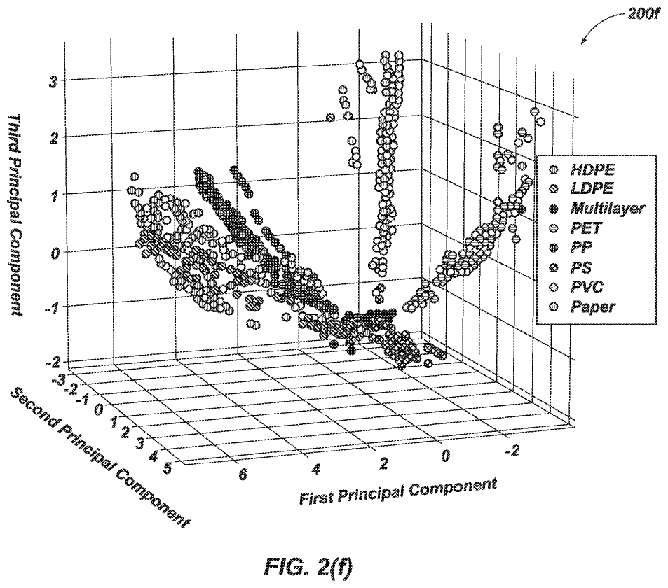

FIGS. 2(a)-2(f) is a group of subplots illustrating the positions of NIR spectra data points of all of the solid waste samples, projected onto a transformed space defined by three principal components with the largest amount of variance according to different preprocessing methods. PCA was performed on all the collected spectra to evaluate the impact of different preprocessing methods. More particularly;

FIG. 2(a) is a subplot 200a illustrating NIR spectra data points of all of the solid waste samples without use of any preprocessing method (i.e., raw NIR spectra);

FIG. 2(b) is a subplot 200b illustrating NIR spectra data points of all of the solid waste samples using smoothing and normalization;

FIG. 2(c) is a subplot 200c illustrating NIR spectra data points of all of the solid waste samples using smoothing, normalization, and application of the first derivative;

FIG. 2(d) is a subplot 200d illustrating NIR spectra data points of all of the solid waste samples using smoothing, normalization, and application of the second derivative;

FIG. 2(e) is a subplot 200e illustrating NIR spectra data points of all of the solid waste samples using smoothing, standardization, and application of the first derivative; and

FIG. 2(f) is a subplot 200f illustrating NIR spectra data points of all of the solid waste samples using smoothing, min-max scaling, and application of the first derivative.

For the unprocessed NIR spectra (i.e., subplot 200a of FIG. 2(a)), the data points show little clustering and significant scattering. After smoothing and normalization (i.e., subplot 200b of FIG. 2(b)), the data points from the same class show signs of clustering, although the distances between different clusters are limited and the scattering within each class is still large, leading to blurred boundaries between different classes. This may compromise the accuracy of classification models. After taking the first or the second derivative of the normalized spectra (i.e., subplot 200c of FIG. 2(c) and subplot 200d of FIG. 2(d), respectively), the projected data points exhibit stronger clustering with increased separating distances between different classes, which may yield improved performance when performing classification.

With reference back to subplot 200c of FIG. 2(d), taking the PCA results of first derivative transformed data as an example, the data points corresponding to PET, PS, and paper are shown to be clearly clustered near the bottom left corner, top left, and middle in the figure, respectively. These data points are distant from the rest of the data points, indicating that these plastics and paper could be classified with high confidence. On the other hand, the data point clusters corresponding to LDPE and HDPE may overlap somewhat in the transformed space, which suggests more caution (e.g., less confidence) when sorting these types of waste. The data points from multilayer packaging exhibit several clusters near those of PET and PE, most likely corresponding to different materials for the composition layers.

The impact of other feature normalization methods besides normalization, namely standardization and min-max scaling, on the PCA result was investigated. PCA was applied to the first derivative transformed and feature normalized spectra, and the results are reproduced in subplot 200e of FIG. 2(e) and subplot 200f of FIG. 2(f). In comparison with subplot 200c of FIG. 2(c), standardization and min-max scaling impact the clustering in a similar fashion, with points of the same classes lying near a straight line. Data points near the cross point of these lines may be difficult to identify. In contrast, the data points exhibit the strongest clustering after normalization, as shown in subplot 200c of FIG. 2(c), which is deemed the most suitable method of feature normalization.

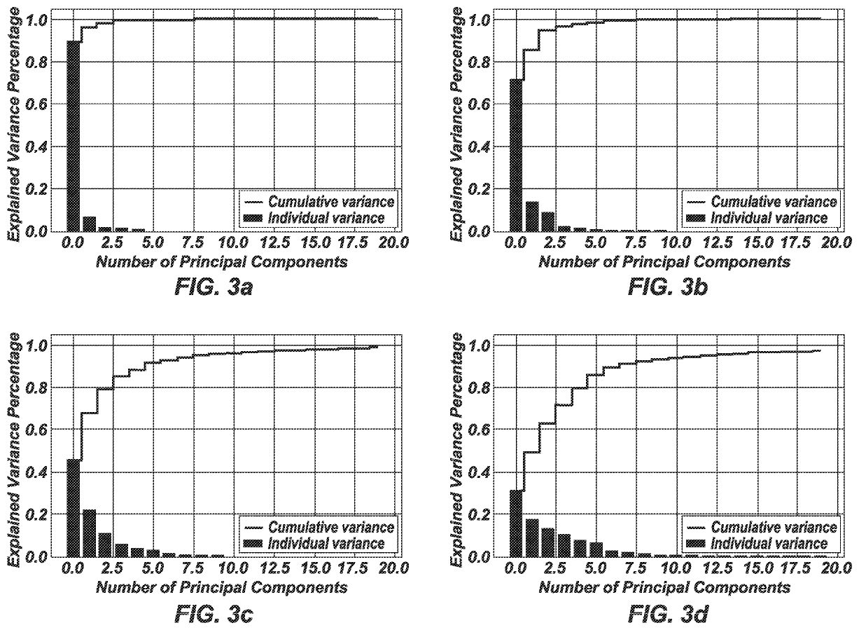

FIGS. 3(a)-3(d) are subplots indicating the impact of preprocessing on a selected (e.g., optimal) number of principal components.

More particularly, FIG. 3(a) is an example with no processing. FIG. 3(b) is an example where the data was smoothed and normalized. FIG. 3(c) is an example where the preprocessing included smoothing, normalization, and a first derivative. FIG. 3(d) is an example where the preprocessing of the data included smoothing, normalization, and a second derivative.

As the dimensionality of the NIR spectrum is significant, PCA may be applied for feature selection to reduce the cost of computation. The selected (e.g., optimal) number of PCs may help to explain over 95% variance in the original dataset. For the raw data, four (4) principal components may be sufficient to explain 99% of the total variance in the data. As the extent of preprocessing increases, more PCs are helpful to explain the same amount of variance. For the data that have taken the first derivative, eight (8) principal components are helpful; for the data that have taken the second derivative, ten (10) or more PCs are helpful.

The impact of different preprocessing methods and ML models on MSW classification are evaluated. The preprocessing methods include normalization, applying a first derivative, and applying a second derivative. All the datasets are smoothed, and the dataset that is not normalized is treated as baseline. The preprocessed dataset is next transformed using PCA to reduce dimensionality. The number of PCs for baseline, first derivative, and second derivative transformed datasets are five (5), eight (8), and ten (10), respectively, based on the previous discussion. The four classification algorithms, namely KNN, SVM, DT, and PLS-DA, were evaluated using the PCA transformed data based on the metrics including precision, recall, F1 score, and accuracy. The results of performance metrics on the training and test sets are summarized in Table 3.

TABLE 3
Performance metrics of four classification models on training and test datasets.

| | | Training set | | | | Test set | | | |
|---|---|---|---|---|---|---|---|---|---|
| Model | Preprocessing | precision | recall | F1 | accuracy | precision | recall | F1 | accuracy |
| KNN | SPC | 0.965 | 0.961 | 0.962 | 0.962 | 0.961 | 0.970 | 0.965 | 0.970 |
| | norm + 1st + | 0.997 | 0.996 | 0.996 | 0.996 | 0.994 | 0.994 | 0.994 | 0.994 |
| | 8PC | | | | | | | | |
| | norm + 2nd + | 0.990 | 0.987 | 0.989 | 0.990 | 0.996 | 0.996 | 0.996 | 0.996 |
| | 10PC | | | | | | | | |
| SVM | 5PC | 0.936 | 0.942 | 0.938 | 0.942 | 0.924 | 0.928 | 0.923 | 0.932 |
| | norm + 1st + | 0.987 | 0.985 | 0.985 | 0.986 | 0.986 | 0.986 | 0.986 | 0.987 |
| | 8PC | | | | | | | | |
| | norm + 2nd + | 0.988 | 0.977 | 0.981 | 0.987 | 0.99 | 0.986 | 0.988 | 0.991 |
| | 10PC | | | | | | | | |
| DT | 5PC | 0.962 | 0.961 | 0.96 | 0.962 | 0.949 | 0.951 | 0.95 | 0.953 |
| | norm + 1st + | 0.983 | 0.981 | 0.981 | 0.985 | 0.984 | 0.989 | 0.986 | 0.989 |
| | 8PC | | | | | | | | |
| | norm + 2nd + | 0.955 | 0.951 | 0.951 | 0.960 | 0.955 | 0.955 | 0.955 | 0.955 |
| | 10PC | | | | | | | | |
| PLS- | 5PC | 0.975 | 0.967 | 0.97 | 0.974 | 0.898 | 0.879 | 0.885 | 0.895 |
| DA | norm + 1st + | 0.982 | 0.97 | 0.974 | 0.984 | 0.915 | 0.875 | 0.889 | 0.913 |
| | 8PC | | | | | | | | |
| | norm + 2nd + | 0.989 | 0.981 | 0.984 | 0.987 | 0.902 | 0.882 | 0.889 | 0.919 |
| | 10PC | | | | | | | | |

A useful method should exhibit high scores of precision, recall, F1, and accuracy. As shown, the KNN model exhibits the highest scores on the first derivative transformed training dataset, with an F1 score of 99.6% on the training dataset. The SVM, DT, and PLS-DA methods exhibit scores on the same order of magnitude. PLS-DA method has the lowest scores on the test dataset, indicating lower generalization capability.

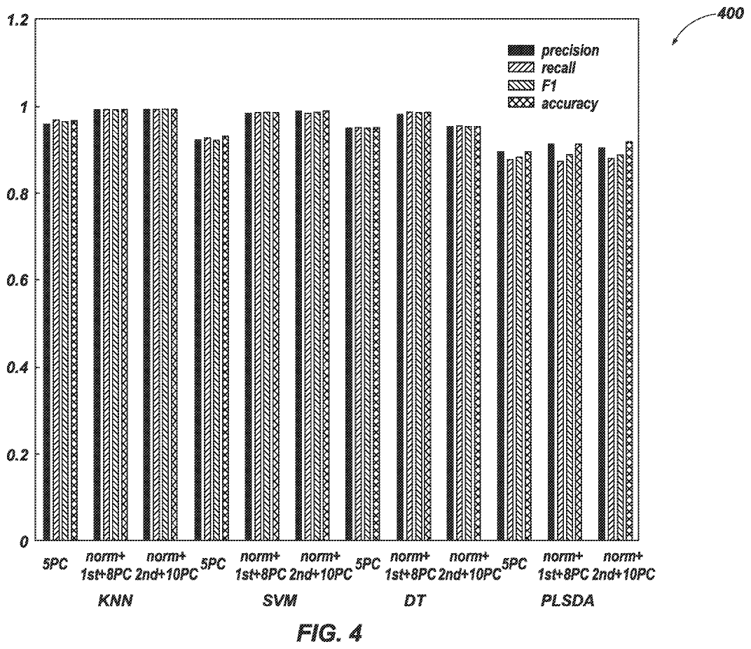

FIG. 4 is a graph 400 showing performance metrics of the four ML models (i.e., KNN, SVM, DT, and PLS-DA) under different preprocessing methods on the test dataset. The metric scores on the test set are illustrated to better compare model performance. Viewing the results, the KNN model on the first or the second derivative transformed data is shown to give the highest scores. The precision, recall, and F1 scores are all above 99%. In contrast, the PLS-DA model consistently gives the lowest scores. DT and SVM methods have comparable performance on the current dataset.

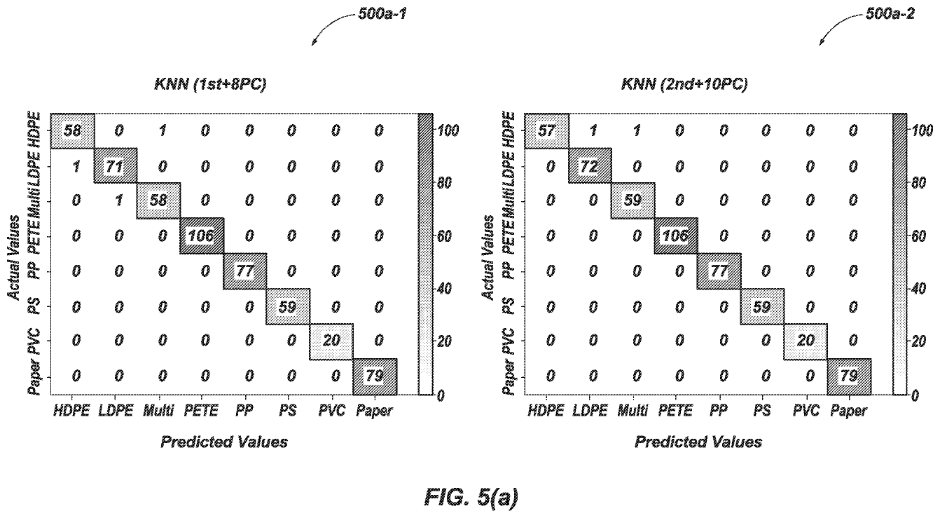

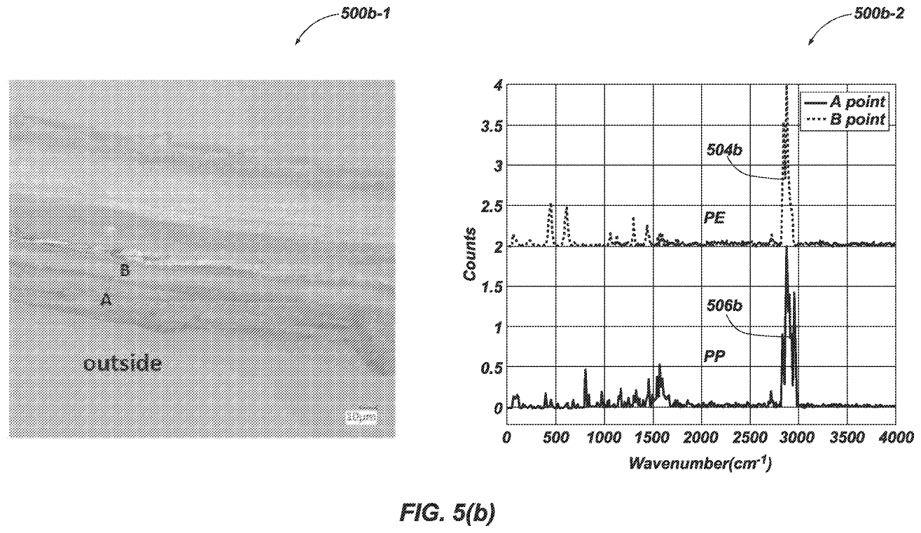

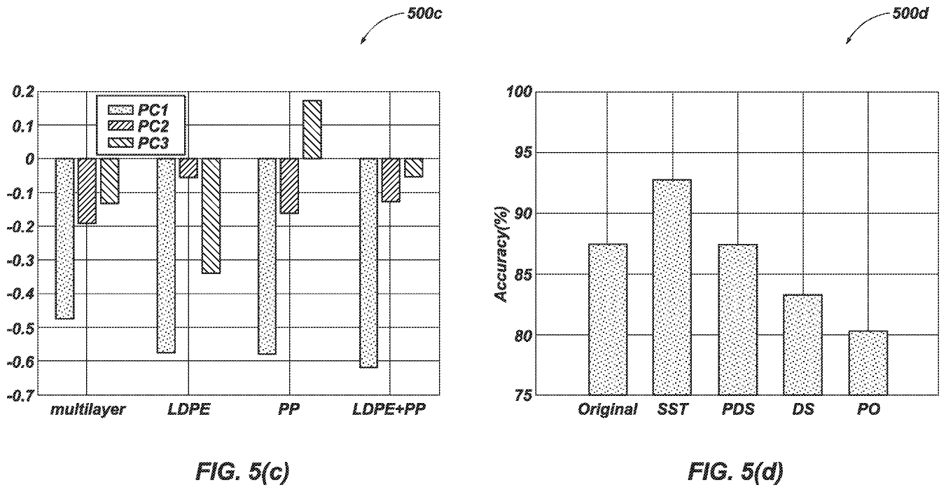

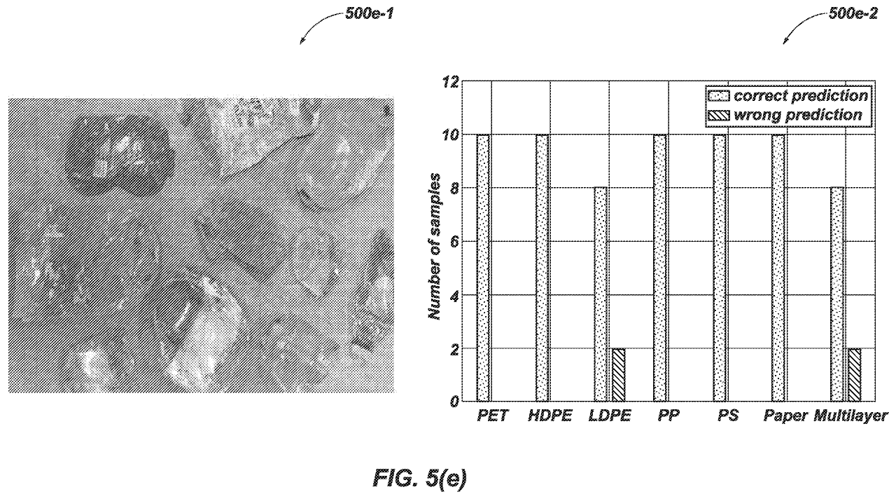

FIGS. 5(a)-5(e) are various figures associated with results and other analysis according to one or more examples of the disclosure. More particularly:

FIG. 5(a) shows a confusion matrix 500a-1 (leftmost side) for the KNN model on the test dataset after preprocessing that includes the first derivative with eight principal components, and a confusion matrix 500a-2 (rightmost side) for the KNN model on the test dataset after preprocessing that includes the second derivative with ten principal components;

FIG. 5(b) shows a microscopic image 500b-1 of one multilayer sample examined by Raman spectroscopy, and Raman spectra 500b-2 collected on two different locations on this sample including a location 504b for PE and a location 506b for PP:

FIG. 5(c) shows a bar chart 500c indicating values of three (3) PCs with the largest variance from different samples associated with multilayer plastics, PDPE, PP, and LDPE+PP;

FIG. 5(d) shows a bar chart 500d indicating prediction accuracy after different calibration transfer methods, including original system, Spectral Space Transformation (SST), Piecewise Direct Standardization (PDS), Direct Standardization (DS), and Orthogonal projection (OP); and

FIG. 5(e) shows an image 500e-1 of various reclaimed MSW and a bar chart 500e-2 of a summary of small-scale classification system performance for various plastic solid waste samples.

The performance of the two KNN models showing the highest metrics in Table 3 is further assessed on the test dataset with confusion matrix 500a-1 of FIG. 5(a), which is a straightforward indication of classification performance on each class of membership. For the first derivative transformed data, one (1) HDPE (1.7%), one (1) LDPE (1.4%), and one (1) Multilayer (1.7%) samples were misclassified. For the second derivative transformed data, misclassification errors also occur between LDPE/HDPE, and multilayer/HDPE. Overall, both models exhibit sufficient performance on the spectrum datasets and demonstrate that NIR spectroscopy coupled with a KNN model enables efficient plastic solid waste classification.

Over the years, less attention has been given to multilayer packaging, which is used in a large portion of food packaging. It has been demonstrated that, using one or more techniques of the disclosure (e.g., using properly trained classification models and data pre-processing), NIR spectroscopy may be adapted to identify multilayer plastics, to sufficiently distinguish them from monolayer plastics, and/or to help further purify the waste stream for downstream recycling.

Raman spectroscopy may be used to reveal a composition of the various constituents of multilayer samples. In one example, one multilayer sample was taken and a microtome was used to slice a section to expose its cross section. The result is provided in microscopic image 500b-1 of FIG. 5(b), which shows a five-layer structure including an aluminum foil in the middle. Using Raman spectroscopy, two measurements were taken at two locations, marked by the letters A and B, on the outside of the foil. The Raman spectra correspond to PP and PE at locations A and B, respectively, indicating that the current sample has PP and PE as the first and second outmost layer material. Furthermore, measurement was taken using NIR spectroscopy on the same side and applied PCA (already fitted to the data in Table 2) to the spectrum.

The values of the first three (3) PCs with the largest variances, which may represent most of the characteristics of the sample, are shown in the bar chart 500c of FIG. 5(c). In addition, FIG. 5(c) shows the values for the same parameters on monolayer LDPE and PP samples. The differences between the values for different samples may be discerned. For LDPE, its PC3 value is smaller than that of multilayer sample. For PP, its PC3 is positive rather than negative like the multilayer sample. These observations are consistent with the results depicted in subplot 200c of FIG. 2(a) and help identify the monolayer MSW.

Next, a new spectrum is created by combining the NIR spectra of LDPE and PP samples to mimic the spectrum collected from a multilayer sample made of LDPE and PP. These two spectra may have the same order of magnitude, and the new spectrum is the summation of two monolayer spectra. The values of PC for this new artificial spectrum (“LDPE+PP”) resemble those from the multilayer sample, which means that the spectrum collected on the multilayer sample is a combined signal originating from each composition layer. This effect causes slight changes to the NIR spectrum that may provide the basis for the sorting of monolayer and multilayer MSW.

After the development of ML models for an MSW classification task, the model on reclaimed MSW is used in a small-scale classification system to demonstrate its capability in a real-world system. In this environment, reclaimed MSW may be contaminated with dust, oil, and mold; the system is loaded into a microcomputer (e.g., a Raspberry Pi (RPi)) equipped with a compact screen for enabling remote and flexible deployment to allow accurate classification of MSW in various situations.

The ML models trained from a dataset acquired from a single NIR spectroscopy system (e.g., NIR spectrometer, light source, optic fiber, and so on) should apply to other systems. Nevertheless, nuances and variations in the hardware and measurement settings may lead to small changes in the optical spectrum that may compromise model performance. One mitigation practice is to perform a calibration transfer method, where mathematical manipulation is implemented on the spectra collected using the new system.

Several calibration transfer methods are evaluated for selection of a preferred method to ensure consistent model performance between old and new systems. Calibration transfer methods include Spectral Space Transformation (SST), Piecewise Direct Standardization (PDS), Direct Standardization (DS), and Orthogonal projection (OP). 168 samples were selected from those in Table 2 and measured using the small-scale NIR classification system that includes an RPi computer and a new spectrometer. Around five (5) spectra of each type were used for calculating the calibration transfer matrix.

Here, the criterion for the preferred calibration transfer is to identify the best model performance on the dataset collected using the new system after the transfer. This is illustrated in the bar chart 500d of FIG. 5(d), where prediction accuracies are plotted before and after applying the different calibration transfer methods. Viewing the results, the SST method gives the highest accuracy after the model transfer, followed by the PDS method. The other methods deteriorate the model performance. Based on the comparison, the SST method may be chosen for the calibration transfer.

The small-scale classification system after calibration transfer was demonstrated on reclaimed MSW samples, shown in image 500e-1 of FIG. 5(e), to assess its performance on contaminated wastes. Ten (10) samples per category were collected, except PVC. The system performance is illustrated in bar chart 500e-2 of FIG. 5(e), where the breakdown of model predictions is shown. The classification system was able to identify in 100% of the cases most of the plastic wastes, except LDPE (where two (2) samples were wrongly classified as HDPE) and multilayer packaging (where two were classified as LDPE and HDPE). The demonstration is consistent with the result of the confusion matrix analysis of FIG. 5(a): that the ML model may identify most of the plastic waste with high confidence, with some errors happening between HDPE/LDPE and HDPE/multilayer. The results also indicate that the system functions even in the presence of contamination, which is applicable for the recycling of MSW.

This disclosure demonstrates that the combination of a miniature NIR spectrometer combined with a robust machine learning model may be employed in a system to classify different plastic types with accuracy. Plastic MSW samples of PET, HDPE, PVC, LDPE, PP, PS, paper, and in particular, multilayer plastic packaging, were included in the database. Various preprocessing methods were tested and the performance of several ML algorithms were discussed. In one or more examples, the KNN model in combination with first derivation and normalization preprocessing gives the highest metrics. In some cases, a source of error may result in misclassification amongst HDPE, LDPE, and multilayer packaging. The demonstrated capability to distinguish between monolayer and multilayer samples may be due to the probing depth of NIR light compared to the film thicknesses, resulting in a combined signal with contributions from each layer. A prototype small-scale classification system was built based on the developed ML model to support a variety of clean applications.

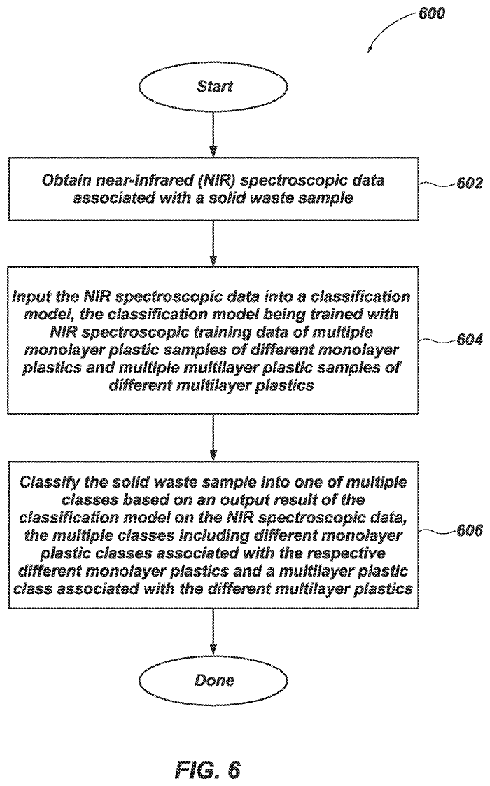

FIG. 6 is a flowchart of a method 600 for classification of plastic solid waste based on NIR spectroscopy according to one or more examples of the disclosure.

In an operation 602, NIR spectroscopic data associated with a solid waste sample is obtained. In an operation 604, the NIR spectroscopic data is input into a classification model. The classification model is (previously) trained with NIR spectroscopic training data of multiple monolayer plastic samples of different monolayer plastics and multiple multilayer plastic samples of different multilayer plastics. In an operation 606, the solid waste sample is classified into one of multiple classes based on an output result of the classification model on the NIR spectroscopic data. The multiple classes include different monolayer plastic classes associated with the respective different monolayer plastics and a multilayer plastic class associated with the different multilayer plastics.

In one or more examples, the classification model utilized in operations 604 and 606 may be an ML model comprising one of a k-nearest neighbor model, a support vector machine model, a decision tree model, or a partial least-squares discriminant analysis model.

In one or more examples, the different monolayer plastics of the multiple monolayer plastic samples of the NIR spectroscopic training data for training the classification model utilized in operations 604 and 606 may be polyethylene terephthalate (PET), high-density polyethylene (HDPE), polyvinyl chloride (PVC), low-density polyethylene (LDPE), polypropylene (PP), polystyrene (PS), and paper; and the different multilayer plastics of the multiple multilayer plastic samples of the NIR spectroscopic training data for training the classification model may include various combinations of two or more of the different monolayer plastics. In one or more examples, the multiple multilayer plastic samples of the NIR spectroscopic training data for training the classification model may include a representative sampling of actual (common) multilayer plastic packaging or items (e.g., common multilayer plastic packaging or items used in commerce and/or found in disposal) (e.g., common multilayer plastic food packaging, common multilayer plastic product packaging, and/or common disposable multilayer plastic product items, and so on).

In one or more examples of operation 602, raw NIR spectral data of the solid waste sample may be acquired from a NIR spectrometer, and the raw NIR spectral data may be pre-processed to produce the NIR spectroscopic data associated with the solid waste sample. In one or more examples, the pre-processing of the raw NIR spectral data may include one or more data pre-processing methods including smoothing, normalizing, applying a first derivative, and applying a second derivative. In one or more examples, the pre-processing may further include transformation using PCA to reduce dimensionality.

In one or more specific examples, the classification model utilized in operations 604 and 606 comprises an ML engine trained with the NIR spectroscopic training data that are pre-processed with one or more predetermined data pre-processing methods and transformed using PCA so that data points of the multiple multilayer plastic samples of the different multilayer plastics are clustered together, and distant (e.g., with the largest variance) from data points of the multiple monolayer plastic samples of the different monolayer plastics. In one or more examples, the one or more predetermined data pre-processing methods may include smoothing, normalizing, and applying a first derivative.

In one or more examples of operation 606, the solid waste sample may be classified in one of the different monolayer plastic classes of the respective different monolayer plastics. In one or more other examples of operation 606, the solid waste sample may be classified in the multilayer plastic class as a multilayer plastic waste sample. In one or more further examples, if the solid waste sample is not classified as one of the different monolayer plastics and is not classified/sorted as a multilayer plastic, then the solid waste sample may be classified as unsortable or unrecyclable waste.

In one or more examples, for respective ones of additional solid waste samples, the method comprises repeating the obtaining in operation 602, the inputting in operation 604, and the classifying in operation 606.

In one or more examples, the solid waste sample is not classified as one of the different monolayer plastics but is classified as a multilayer plastic (not unsortable or unrecyclable waste). In response, Raman spectroscopic data associated with the multilayer plastic sample are obtained. One or more compositions of one or more layers of the multilayer plastic sample are determined based on the Raman spectroscopic data. The multilayer plastic sample may then be classified into one of multiple classes of different multilayer plastics based on the one or more determined compositions of the one or more layers of the multilayer plastic sample. In one or more examples, the multiple classes of the respective different multilayer plastics comprise the various combinations of two or more of the different monolayer plastics (e.g., the various combinations of two or more of PET, HDPE, PVC, LDPE, PP, PS, and paper). In one or more examples, for respective ones of additional solid waste samples, the method comprises repeating the obtaining in operation 602, the inputting in operation 604, and the classifying in operation 606, including the repeating of the obtaining, the determining, and the further classification based on Raman spectroscopy.

In one or more examples, the method 600 of FIG. 6 may be employed in a system for sorting and/or recycling plastic solid waste.

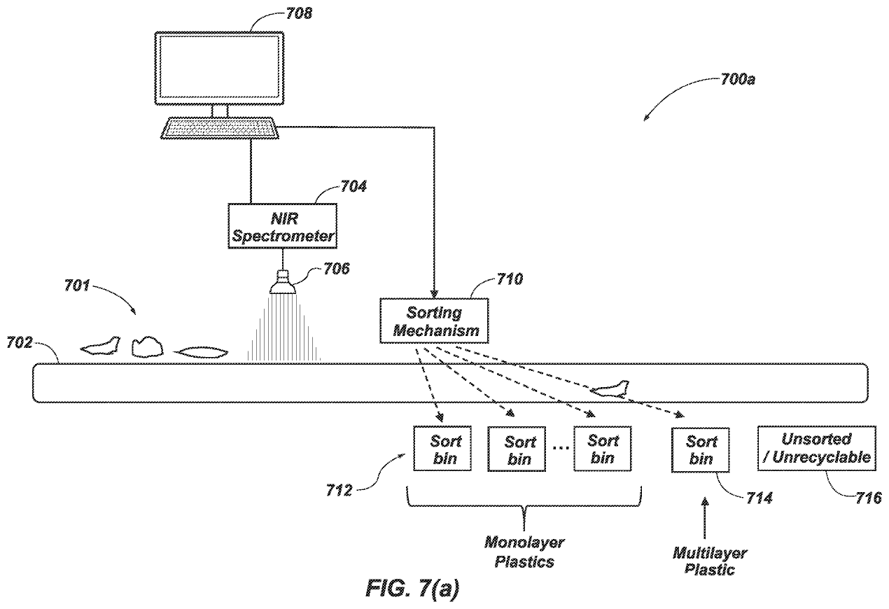

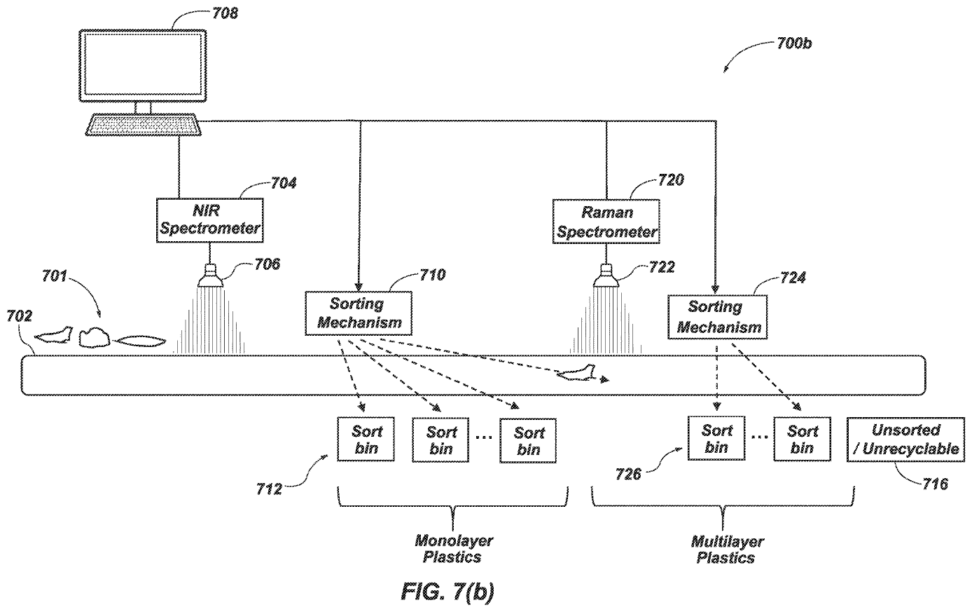

FIG. 7(a) is a system 700a for sorting and/or recycling plastic solid waste according to one or more examples of the disclosure. System 700a comprises a conveyor system 702 for conveying solid waste samples 701 (e.g., plastic solid waste), an NIR spectrometer 704 including one or more light sources 706, a computing apparatus 708, and a sorting mechanism 710.

Computing apparatus 708 (e.g., a computer or microcomputer) comprises a data storage device and one or more processors. The data storage device is used to store machine-executable code including executable instructions to adapt or enable the one or more processors to perform a method for classification/sorting of plastic solid waste (e.g., method 600 of FIG. 6). The executable instructions define or interface with the classification model that comprises the ML engine trained with the NIR spectroscopic training data associated with the different monolayer plastics (i.e., the multiple monolayer plastic samples including PET, HDPE, PVC, LDPE, PP, PS, and paper) and the different multilayer plastics (i.e., the multiple multilayer plastic samples associated with the various combinations of two or more of the different monolayer plastics).

During operation, one of the solid waste samples 701 is conveyed via conveyor system 702. Raw NIR spectral data of the solid waste sample are acquired from NIR spectrometer 704. Computing apparatus 708 receives and pre-processes the raw NIR spectral data (e.g., using one or more pre-processing methods and/or PCA) to produce and obtain the NIR spectroscopic data associated with the solid waste sample. Computing apparatus 708 inputs the obtained NIR spectroscopic data into the classification model that processes the data to produce an output result. The solid waste sample is classified into one of the multiple classes based on the output result. The multiple classes include the different monolayer plastic classes associated with the respective different monolayer plastics and the multilayer plastic class associated with the different multilayer plastics.

Sorting mechanism 710 is operably coupled to computing apparatus 708 for sorting the solid waste sample into one or multiple different sorting bins 712 responsive to the output result or classification. The sorting bins 712 are associated with respective different monolayer plastic classes/groupings of the different monolayer plastics. Sorting bins 712 may further include a sorting bin 714 for multilayer plastics, which is a multilayer plastic grouping separate from the different monolayer plastic groupings. If a solid waste sample is not classified/sorted as one of the different monolayer plastics and is not classified/sorted as a multilayer plastic, then the solid waste sample is classified/sorted as unsortable or unrecyclable waste (e.g., in an unsortable/unrecyclable waste bin 716).

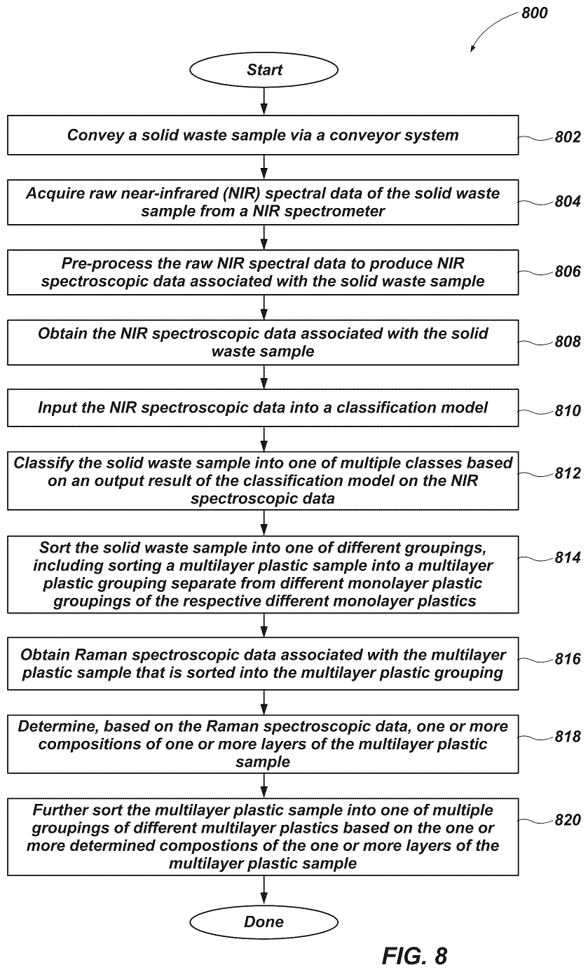

FIG. 7(b) is another system 700b for sorting and/or recycling plastic solid waste according to one or more examples of the disclosure. Like system 700a of FIG. 7(a), system 700b of FIG. 7(b) comprises conveyor system 702 for conveying solid waste samples 701 (e.g., plastic solid waste), NIR spectrometer 704 including one or more light sources 706, computing apparatus 708, sorting mechanism 710, and multiple different sorting bins 712. System 700b further includes a sub-system for multilayer plastics that comprises a Raman spectrometer 720 including one or more light sources 722, a sorting mechanism 724 (e.g., separate from sorting mechanism 710, or an extension or part of the same mechanism, without limitation), and multiple different sorting bins 726 for respective different multilayer plastics. System 700b of FIG. 7(b) will be referenced in relation to the method of FIG. 8 described below.

FIG. 8 is a flowchart of a method 800 of efficiently sorting and/or recycling plastic solid waste based on NIR and Raman spectroscopy according to one or more examples of the disclosure. In an operation 802, a solid waste sample is conveyed via a conveyor system (e.g., conveyor system 702 of FIG. 7(b)). In an operation 804, raw NIR spectral data of the solid waste sample is acquired from a NIR spectrometer (e.g., NIR spectrometer 704 of FIG. 7(b)). In an operation 806, the raw NIR spectral data is pre-processed to produce the NIR spectroscopic data associated with the solid waste sample (e.g., in computing apparatus 708 of FIG. 7(b)). Accordingly, in an operation 808, the NIR spectroscopic data associated with the solid waste sample is obtained. In an operation 810, the NIR spectroscopic data is input into a classification model (e.g., in computing apparatus 708 of FIG. 7(b)). The classification model is trained with NIR spectroscopic training data of multiple monolayer plastic samples of different monolayer plastics and multiple multilayer plastic samples of different multilayer plastics. In an operation 812, the solid waste sample is classified into one of multiple classes based on an output result of the classification model on the NIR spectroscopic data. The multiple classes include different monolayer plastic classes associated with the respective different monolayer plastics and a multilayer plastic class associated with the different multilayer plastics.

In one or more examples, the classification model utilized in operations 810 and 812 may be an ML model comprising one of a k-nearest neighbor model, a support vector machine model, a decision tree model, or a partial least-squares discriminant analysis model.

In one or more examples, the different monolayer plastics of the multiple monolayer plastic samples of the NIR spectroscopic training data for training the classification model utilized in operations 810 and 812 comprise polyethylene terephthalate, high-density polyethylene, polyvinyl chloride, low-density polyethylene, polypropylene, polystyrene, and paper, and the different multilayer plastics of the multiple multilayer plastic samples of the NIR spectroscopic training data for training the classification model comprise various combinations of two or more of the different monolayer plastics. In one or more examples, the multiple multilayer plastic samples of the NIR spectroscopic training data for training the classification model comprise a representative sampling of actual (common) multilayer plastic packaging or items (e.g., common multilayer plastic packaging or items used in commerce and/or found in disposal) (e.g., common multilayer plastic food packaging, common multilayer plastic product packaging, and/or common disposable multilayer plastic product items, and so on).

In one or more examples, the pre-processing of the raw NIR spectral data in operation 806 comprises one or more data pre-processing methods including smoothing, normalizing, applying a first derivative, and applying a second derivative. In one or more examples, the pre-processing in operation 806 further comprises transformation using PCA to reduce dimensionality.

In one or more specific examples, the classification model utilized in operations 810 and 812 comprises an ML engine trained with the NIR spectroscopic training data that are pre-processed with one or more predetermined data pre-processing methods and transformed using PCA so that data points of the multiple multilayer plastic samples of the different multilayer plastics are clustered together, and distant (e.g., with the largest variance) from data points of the multiple monolayer plastic samples of the different monolayer plastics. In one or more examples, the one or more predetermined data pre-processing methods consist of smoothing, normalizing, and applying a first derivative.

In an operation 814, the solid waste sample is sorted into one of different groupings based on the classification made in operation 812 (e.g., using sorting mechanism 710 of FIG. 7(b)). In one or more examples, the solid waste sample is classified in one of the different monolayer plastic classes of the respective different monolayer plastics; therefore, the solid waste sample is sorted into one of different monolayer plastic groupings of the respective different monolayer plastics (e.g., in an appropriate one of sorting bins 712 of FIG. 7(b)). In one or more other examples of operation 814, the solid waste sample is classified in the multilayer plastic class as a multilayer plastic waste sample. Here, operation 814 includes sorting the multilayer plastic waste sample into a multilayer plastic grouping or area, which is separate from the different monolayer plastic groupings of the respective different monolayer plastics.

In one or more examples, for respective ones of additional solid waste samples, the method comprises repeating the conveying in operation 802, the acquiring in operation 804, the pre-processing in operation 806, the obtaining in operation 808 (redundant or optional step), the inputting in operation 810, the classifying in operation 812, and the sorting in operation 814.

In one or more examples, the solid waste sample is not classified/sorted as one of the different monolayer plastics but is classified/sorted as a multilayer plastic (not unsortable or unrecyclable waste). Here, in an operation 816, Raman spectroscopic data associated with the multilayer plastic sample that is sorted into the multilayer plastic grouping are obtained (e.g., using Raman spectrometer 720 of FIG. 7(b)). In an operation 818, one or more compositions of one or more layers of the multilayer plastic sample are determined based on the Raman spectroscopic data (e.g., using computing apparatus 708 of FIG. 7(b)). In an operation 820, the multilayer plastic sample is further sorted into one of multiple groupings of different multilayer plastics based on the one or more determined compositions of the one or more layers of the multilayer plastic sample (e.g., using sorting mechanism 724 of FIG. 7(b), in an appropriate one of sorting bins 726 of FIG. 7(b)). In one or more examples of operation 820, the multiple groupings of the respective different multilayer plastics correspond to the respective various combinations of two or more of the different monolayer plastics (e.g., the various combinations of two or more of polyethylene terephthalate, high-density polyethylene, polyvinyl chloride, low-density polyethylene, polypropylene, polystyrene, and paper).

In one or more examples, if the solid waste sample is not classified/sorted as one of the different monolayer plastics and is not classified/sorted as a multilayer plastic, then the solid waste sample is classified/sorted as unsortable or unrecyclable waste (e.g., in unsortable/unrecyclable waste bin 716 of FIG. 7(b)).

In one or more examples, for respective ones of additional solid waste samples, the method comprises repeating the conveying in operation 802, the acquiring in operation 804, the pre-processing in operation 806, the obtaining in operation 808 (redundant or optional step), the inputting in operation 810, the classifying in operation 812, the sorting in operation 814, the obtaining in operation 816, the determining in operation 818, and the further sorting in operation 820.

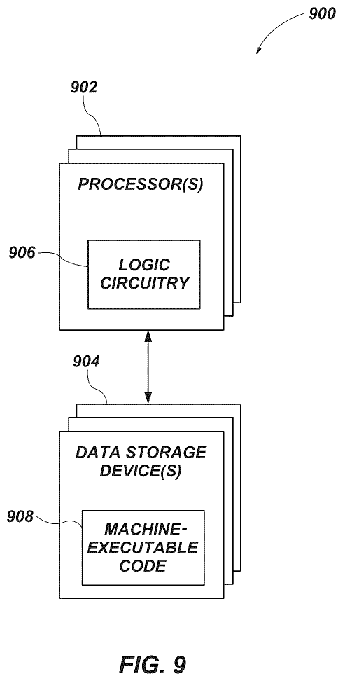

FIG. 9 is a block diagram of an example device 900 that, in various examples, may be used to implement various functions, operations, acts, processes, and/or methods disclosed herein. Device 900 includes one or more processors 902 (sometimes referred to herein as “processors 902”) operably coupled to one or more apparatuses such as data storage devices (sometimes referred to herein as “storage 904”), without limitation. Storage 904 includes machine-executable code 908 stored thereon (e.g., stored on a computer-readable memory) and processors 902 include logic circuitry 906. Machine-executable code 908 includes information describing functional elements that may be implemented by (e.g., performed by) logic circuitry 906. Logic circuitry 906 is adapted to implement (e.g., perform) the functional elements described by machine-executable code 908. Device 900, when executing the functional elements described by machine-executable code 908, should be considered as special purpose hardware for carrying out the functional elements disclosed herein. In various examples, processors 902 may perform the functional elements described by machine-executable code 908 sequentially, concurrently (e.g., on one or more different hardware platforms), or in one or more parallel process streams.

When implemented by logic circuitry 906 of processors 902, machine-executable code 908 is to adapt processors 902 to perform operations of examples disclosed herein. For example, machine-executable code 908 may adapt processors 902 to perform at least a portion or a totality of method 600 of FIG. 6. For example, machine-executable code 908 may adapt processors 902 to perform at least a portion or a totality of method 800 of FIG. 8.

Processors 902 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is to execute computing instructions (e.g., software code) related to examples of the present disclosure. It is noted that a general-purpose processor (may also be referred to herein as a host processor or simply a host) may be a microprocessor, but in the alternative, processors 902 may include any conventional processor, controller, microcontroller, or state machine. Processors 902 may also be implemented as a combination of computing devices, such as a combination of a DSP and a microprocessor, a plurality of microprocessors, one or more microprocessors in conjunction with a DSP core, or any other such configuration.

In various examples, storage 904 includes volatile data storage (e.g., random-access memory (RAM)), non-volatile data storage (e.g., Flash memory, a hard disc drive, a solid-state drive, erasable programmable read-only memory (EPROM), without limitation). In various examples, processors 902 and storage 904 may be implemented into a single device (e.g., a semiconductor device product, a system on chip (SOC), without limitation). In various examples, processors 902 and storage 904 may be implemented into separate devices.

In various examples, machine-executable code 908 may include computer-readable instructions (e.g., software code, firmware code). By way of non-limiting example, the computer-readable instructions may be stored by storage 904, accessed directly by processors 902, and executed by processors 902 using at least logic circuitry 906. Also, by way of non-limiting example, the computer-readable instructions may be stored on storage 904, transmitted to a memory device (not shown) for execution, and executed by processors 902 using at least logic circuitry 906. Accordingly, in various examples, logic circuitry 906 includes electrically configurable logic circuitry.

In various examples, machine-executable code 908 may describe hardware (e.g., circuitry) to be implemented in logic circuitry 906 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, VERILOG™, SYSTEMVERILOG™ or very large-scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 906 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in various examples, machine-executable code 908 may include an HDL, an RTL, a GL description, a mask level description, other hardware description, or any combination thereof.

In examples where machine-executable code 908 includes a hardware description (at any level of abstraction), a system (not shown, but including storage 904) may implement the hardware description described by machine-executable code 908. By way of non-limiting example, processors 902 may include a programmable logic device (e.g., an FPGA or a PLC) and the logic circuitry 906 may be electrically controlled to implement circuitry corresponding to the hardware description into logic circuitry 906. Also, by way of non-limiting example, logic circuitry 906 may include hard-wired logic manufactured by a manufacturing system (not shown but including storage 904) according to the hardware description of machine-executable code 908.

Regardless of whether machine-executable code 908 includes computer-readable instructions or a hardware description, logic circuitry 906 is adapted to perform the functional elements described by machine-executable code 908 when implementing the functional elements of machine-executable code 908. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D, B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Note that each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: A method, comprising: obtaining near-infrared (NIR) spectroscopic data associated with a solid waste sample; inputting the NIR spectroscopic data into a classification model, the classification model being trained with NIR spectroscopic training data of multiple monolayer plastic samples of different monolayer plastics and multiple multilayer plastic samples of different multilayer plastics; and classifying the solid waste sample into one of multiple classes based on an output result of the classification model on the NIR spectroscopic data, the multiple classes including different monolayer plastic classes associated with the respective different monolayer plastics and a multilayer plastic class associated with the different multilayer plastics.

Example 2: The method according to Example 1, wherein the classification model is a machine-learning (ML) model comprising one of: a k-nearest neighbor model, a support vector machine model, a decision tree model, and a partial least-squares discriminant analysis model.

Example 3: The method according to Examples 1 and 2, wherein the solid waste sample comprises a multilayer plastic sample, and the classifying comprises: classifying the solid waste sample into the multilayer plastic class associated with the different multilayer plastics.

Example 4: The method according to Examples 1 through 3, comprising: sorting the solid waste sample into a multilayer plastic grouping that is separate from different monolayer plastic groupings of the respective different monolayer plastics.

Example 5: The method according to Examples 1 through 4, comprising: obtaining Raman spectroscopic data associated with the multilayer plastic sample that is sorted into the multilayer plastic grouping; and determining, based on the Raman spectroscopic data, one or more compositions of one or more layers of the multilayer plastic sample.

Example 6: The method according to Examples 1 through 5, wherein obtaining near-infrared (NIR) spectroscopic data associated with a solid waste comprises: conveying the solid waste sample to an NIR spectrometer via a conveyor system; acquiring raw NIR spectral data of the solid waste sample from the NIR spectrometer; and pre-processing the raw NIR spectral data to produce the NIR spectroscopic data associated with the solid waste sample.

Example 7: The method according to Examples 1 through 6, wherein the pre-processing of the raw NIR spectral data comprises one or more data pre-processing methods including: smoothing, normalizing, applying a first derivative, and applying a second derivative of the raw NIR spectral data.

Example 8: The method according to Examples 1 through 7, comprising: for respective ones of additional solid waste samples: repeating the conveying, the acquiring, the pre-processing, the obtaining, the inputting, and the classifying.

Example 9: The method according to Examples 1 through 8, wherein: the different monolayer plastics of the multiple monolayer plastic samples of the NIR spectroscopic training data comprise: polyethylene terephthalate, high-density polyethylene, polyvinyl chloride, low-density polyethylene, polypropylene, polystyrene, and paper, and the different multilayer plastics of the multiple multilayer plastic samples of the NIR spectroscopic training data comprise various combinations of two or more of the different monolayer plastics, or the multiple multilayer plastic samples of the NIR spectroscopic training data for training the classification model comprise a representative sampling of actual multilayer plastic packaging.

Example 10: The method according to Examples 1 through 9, wherein the classification model comprises a machine learning (ML) engine trained with the NIR spectroscopic training data that are pre-processed with one or more predetermined data pre-processing methods and transformed using Principal Component Analysis (PCA) so that data points of the multiple multilayer plastic samples of the different multilayer plastics are clustered together and distant from data points of the multiple monolayer plastic samples of the different monolayer plastics.

Example 11: The method according to Examples 1 through 10, wherein the one or more predetermined data pre-processing methods consist of: smoothing, normalizing, and applying a first derivative.

Example 12: The method according to Examples 1 through 11, comprising: further sorting the multilayer plastic sample into one of multiple groupings of different multilayer plastics based on the one or more determined compositions of the one or more layers of the multilayer plastic sample.

Example 13: An apparatus, comprising: one or more processors; and a data storage device to store machine-executable code including executable instructions to adapt or enable the one or more processors to: obtain near-infrared (NIR) spectroscopic data associated with a solid waste sample; input the NIR spectroscopic data into a classification model, the classification model being trained with NIR spectroscopic training data of multiple monolayer plastic samples of different monolayer plastics and multiple multilayer plastic samples of different multilayer plastics; and classify the solid waste sample into one of multiple classes based on an output result of the classification model on the NIR spectroscopic data, the multiple classes including different monolayer plastic classes associated with the respective different monolayer plastics and a multilayer plastic class associated with the different multilayer plastics.

Example 14: The apparatus according to Example 13, wherein the classification model comprises a machine learning (ML) engine trained with the NIR spectroscopic training data that are pre-processed with one or more predetermined data pre-processing methods and transformed using Principal Component Analysis (PCA) so that data points of the multiple multilayer plastic samples of the different multilayer plastics are clustered together and distant from data points of the multiple monolayer plastic samples of the different monolayer plastics.

Example 15: The apparatus according to Examples 13 and 14, wherein the one or more predetermined data pre-processing methods consist of: smoothing, normalizing, and applying a first derivative.

Example 16: The apparatus according to Examples 13 through 15, wherein the solid waste sample comprises a multilayer plastic sample that is sorted into a multilayer plastic grouping based on classification in the multilayer plastic class, and the one or more processors is adapted or enabled by the executable instructions of the machine-executable code to: obtain Raman spectroscopic data associated with the multilayer plastic sample, and determine, based on the Raman spectroscopic data, one or more compositions of one or more layers of the multilayer plastic sample.

Example 17: A system comprising: a near-infrared (NIR) spectrometer to acquire raw NIR spectral data of a solid waste sample; a data storage device to store machine-executable code; one or more processors adapted or enabled by executable instructions of the machine-executable code to: obtain NIR spectroscopic data associated with the solid waste sample, the NIR spectroscopic data based on the raw NIR spectral data of the solid waste sample; input the NIR spectroscopic data into a classification model, the classification model being trained with NIR spectroscopic training data of multiple monolayer plastic samples of different monolayer plastics and multiple multilayer plastic samples of different multilayer plastics; and classify the solid waste sample into one of multiple classes according to an output of the classification model on the NIR spectroscopic data, the multiple classes including different monolayer plastic classes associated with the respective different monolayer plastics and a multilayer plastic class associated with the different multilayer plastics.

Example 18: The system according to Example 17, wherein the solid waste sample comprises a multilayer plastic sample that is classified into the multilayer plastic class associated with the different multilayer plastics, the system comprising: a conveyor system to convey the solid waste sample; and a sorting mechanism to sort the solid waste sample into a multilayer plastic grouping that is separate from different monolayer plastic groupings of the respective different monolayer plastics.

Example 19: The system according to Examples 17 and 18, wherein: the one or more processors is adapted or enabled by the executable instructions of the machine-executable code to: obtain Raman spectroscopic data associated with the multilayer plastic sample that is sorted into the multilayer plastic grouping, and determine, based on the Raman spectroscopic data, one or more compositions of one or more layers of the multilayer plastic sample, and the sorting mechanism is to further sort the multilayer plastic sample into one of multiple groupings of different multilayer plastics based on the one or more determined compositions of the one or more layers of the multilayer plastic sample.

Example 20: The system according to Examples 17 through 19, wherein the classification model comprises a machine learning (ML) engine trained with the NIR spectroscopic training data that are pre-processed with one or more predetermined data pre-processing methods and transformed using Principal Component Analysis (PCA) so that data points of the multiple multilayer plastic samples of the different multilayer plastics are clustered together and distant from data points of the multiple monolayer plastic samples of the different monolayer plastics.

While the present disclosure has been described herein with respect to certain illustrated embodiments, those of ordinary skill in the art will recognize and appreciate that the present disclosure is not so limited. Rather, many additions, deletions, and modifications to the illustrated and described embodiments may be made without departing from the scope of the disclosure as hereinafter claimed along with their legal equivalents. In addition, features from one embodiment may be combined with features of another embodiment while still being encompassed within the scope of the disclosure as contemplated by the inventor.

1. A method, comprising:
obtaining near-infrared (NIR) spectroscopic data associated with a solid waste sample;
inputting the NIR spectroscopic data into a classification model, the classification model being trained with NIR spectroscopic training data of multiple monolayer plastic samples of different monolayer plastics and multiple multilayer plastic samples of different multilayer plastics; and
classifying the solid waste sample into one of multiple classes based on an output result of the classification model on the NIR spectroscopic data, the multiple classes including different monolayer plastic classes associated with the respective different monolayer plastics and a multilayer plastic class associated with the different multilayer plastics.

2. The method of claim 1, wherein the classification model is a machine-learning (ML) model comprising one of: a k-nearest neighbor model, a support vector machine model, a decision tree model, and a partial least-squares discriminant analysis model.

3. The method of claim 1, wherein the solid waste sample comprises a multilayer plastic sample, and the classifying comprises:
classifying the solid waste sample into the multilayer plastic class associated with the different multilayer plastics.

4. The method of claim 3, comprising:
sorting the solid waste sample into a multilayer plastic grouping that is separate from different monolayer plastic groupings of the respective different monolayer plastics.

5. The method of claim 4, comprising:
obtaining Raman spectroscopic data associated with the multilayer plastic sample that is sorted into the multilayer plastic grouping; and
determining, based on the Raman spectroscopic data, one or more compositions of one or more layers of the multilayer plastic sample.

6. The method of claim 1, wherein obtaining the NIR spectroscopic data associated with the solid waste sample comprises:
conveying the solid waste sample to a NIR spectrometer via a conveyor system;
acquiring raw NIR spectral data of the solid waste sample from the NIR spectrometer; and
pre-processing the raw NIR spectral data to produce the NIR spectroscopic data associated with the solid waste sample.

7. The method of claim 6, wherein the pre-processing of the raw NIR spectral data comprises one or more data pre-processing methods including: smoothing, normalizing, applying a first derivative, and applying a second derivative of the raw NIR spectral data.

8. The method of claim 6, comprising:
for respective ones of additional solid waste samples:
repeating the conveying, the acquiring, the pre-processing, the obtaining, the inputting, and the classifying.

9. The method of claim 3, wherein:
the different monolayer plastics of the multiple monolayer plastic samples of the NIR spectroscopic training data comprise: polyethylene terephthalate, high-density polyethylene, polyvinyl chloride, low-density polyethylene, polypropylene, polystyrene, and paper, and
the different multilayer plastics of the multiple multilayer plastic samples of the NIR spectroscopic training data comprise various combinations of two or more of the different monolayer plastics, or
the multiple multilayer plastic samples of the NIR spectroscopic training data for training the classification model comprise a representative sampling of actual multilayer plastic packagings.

10. The method of claim 1, wherein the classification model comprises a machine learning (ML) engine trained with the NIR spectroscopic training data that are pre-processed with one or more predetermined data pre-processing methods and transformed using Principal Component Analysis (PCA) so that data points of the multiple multilayer plastic samples of the different multilayer plastics are clustered together and distant from data points of the multiple monolayer plastic samples of the different monolayer plastics.

11. The method of claim 10, wherein the one or more predetermined data pre-processing methods consist of: smoothing, normalizing, and applying a first derivative.

12. The method of claim 5, comprising:
further sorting the multilayer plastic sample into one of multiple groupings of different multilayer plastics based on the one or more determined compositions of the one or more layers of the multilayer plastic sample.

13. An apparatus, comprising:
one or more processors; and
a data storage device to store machine-executable code including executable instructions to adapt or enable the one or more processors to:
obtain near-infrared (NIR) spectroscopic data associated with a solid waste sample;
input the NIR spectroscopic data into a classification model, the classification model being trained with NIR spectroscopic training data of multiple monolayer plastic samples of different monolayer plastics and multiple multilayer plastic samples of different multilayer plastics; and
classify the solid waste sample into one of multiple classes based on an output result of the classification model on the NIR spectroscopic data, the multiple classes including different monolayer plastic classes associated with the respective different monolayer plastics and a multilayer plastic class associated with the different multilayer plastics.

14. The apparatus of claim 13, wherein the classification model comprises a machine learning (ML) engine trained with the NIR spectroscopic training data that are pre-processed with one or more predetermined data pre-processing methods and transformed using Principal Component Analysis (PCA) so that data points of the multiple multilayer plastic samples of the different multilayer plastics are clustered together and distant from data points of the multiple monolayer plastic samples of the different monolayer plastics.

15. The apparatus of claim 14, wherein the one or more predetermined data pre-processing methods consist of: smoothing, normalizing, and applying a first derivative.

16. The apparatus of claim 13, wherein the solid waste sample comprises a multilayer plastic sample that is sorted into a multilayer plastic grouping based on classification in the multilayer plastic class, and the one or more processors is adapted or enabled by the executable instructions of the machine-executable code to:
obtain Raman spectroscopic data associated with the multilayer plastic sample, and
determine, based on the Raman spectroscopic data, one or more compositions of one or more layers of the multilayer plastic sample.

17. A system comprising:
a near-infrared (NIR) spectrometer configured to acquire raw NIR spectral data of a solid waste sample;
a data storage device configured to store machine-executable code;
one or more processors adapted or enabled by executable instructions of the machine-executable code to:
obtain NIR spectroscopic data associated with the solid waste sample, the NIR spectroscopic data based on the raw NIR spectral data of the solid waste sample;
input the NIR spectroscopic data into a classification model, the classification model being trained with NIR spectroscopic training data of multiple monolayer plastic samples of different monolayer plastics and multiple multilayer plastic samples of different multilayer plastics; and
classify the solid waste sample into one of multiple classes according to an output of the classification model on the NIR spectroscopic data, the multiple classes including different monolayer plastic classes associated with the respective different monolayer plastics and a multilayer plastic class associated with the different multilayer plastics.

18. The system of claim 17, wherein the solid waste sample comprises a multilayer plastic sample that is classified into the multilayer plastic class associated with the different multilayer plastics, the system comprising:
a conveyor system configured to convey the solid waste sample; and
a sorting mechanism configured to sort the solid waste sample into a multilayer plastic grouping that is separate from different monolayer plastic groupings of the respective different monolayer plastics.

19. The system of claim 18, wherein:
the one or more processors is adapted or enabled by the executable instructions of the machine-executable code to:
obtain Raman spectroscopic data associated with the multilayer plastic sample that is sorted into the multilayer plastic grouping, and
determine, based on the Raman spectroscopic data, one or more compositions of one or more layers of the multilayer plastic sample, and
the sorting mechanism is configured to further sort the multilayer plastic sample into one of multiple groupings of different multilayer plastics based on the one or more determined compositions of the one or more layers of the multilayer plastic sample.

20. The system of claim 19, wherein the classification model comprises a machine learning (ML) engine trained with the NIR spectroscopic training data that are pre-processed with one or more predetermined data pre-processing methods and transformed using Principal Component Analysis (PCA) so that data points of the multiple multilayer plastic samples of the different multilayer plastics are clustered together and distant from data points of the multiple monolayer plastic samples of the different monolayer plastics.
